(19) United States
(12) Patent Application Publication
(10) Pub. No.: US 2026/0293839 A1
(43) Pub. Date: Oct. 1, 2026

(54) PET CRATE

(71) Applicant: JIANGSU ZHONGHENG PET ARTICLES JOINT-STOCK CO., LTD., Yancheng City (CN)

(72) Inventor: Bin QIU, Yancheng City (CN)

(21) Appl. No.: 19/417,244

(22) Filed: Dec. 11, 2025

(30) Foreign Application Priority Data
Mar. 25, 2025 (CN) 202520533923.7

(51) Int. Cl. A01K 1/02

(52) U.S. Cl. CPC A01K 1/0245

(57) ABSTRACT

Provided is a pet crate, including a plurality of mesh panels configured to define a closed accommodating chamber; a door connected to one of the plurality of mesh panels; and connection assemblies, where each of the connection assemblies is arranged between two respective adjacent mesh panels of the plurality of mesh panels. Through the arrangement of the connection assembly between two adjacent mesh panels, the two adjacent mesh panels can be assembled together by sliding one of the two adjacent mesh panels relative to the other of the two adjacent mesh panels. As such, the number of screws used is reduced, and the mounting efficiency is greatly improved.

### CROSS REFERENCE TO THE RELATED APPLICATIONS

This application is based upon and claims priority to Chinese Patent Application No. 202520533923.7, filed on Mar. 25, 2025, the entire contents of which are incorporated herein by reference.

### TECHNICAL FIELD

The present disclosure relates to the field of pet products, and specifically to a pet crate.

### BACKGROUND

At present, pet crates on the market are basically composed of six individual frames and several fasteners. The six individual frames include a top frame, a bottom frame, a front frame, a rear frame, a left frame, and a right frame. A door is provided in the front frame. During mounting of such a pet crate, two adjacent individual frames need to be assembled together using a large number of screws or other fasteners to improve the stability of the entire structure. However, the use of the screws or other fasteners makes the mounting process cumbersome and reduces the mounting efficiency.

### SUMMARY

To solve the technical problem that the use of a large number of screws or other fasteners to assemble two adjacent individual frames together makes the mounting process cumbersome and reduces the mounting efficiency, an objective of the present disclosure is to provide a pet crate.

To achieve the above objective, an embodiment of the present disclosure provides a pet crate, including:
a plurality of mesh panels, where the plurality of mesh panels are configured to define a closed accommodating chamber;
a door, where the door is connected to one of the plurality of mesh panels; and connection assemblies, where each of the connection assemblies is arranged between two respective adjacent mesh panels of the plurality of mesh panels.

In the above technical solution, each of the connection assemblies includes:
a first connection member, where the first connection member is arranged at a connection between the two respective adjacent mesh panels and is connected to one of the two respective adjacent mesh panels, and a slide groove is provided on the first connection member; and
a second connection member, where the second connection member is arranged at the connection between the two respective adjacent mesh panels and is connected to the other of the two respective adjacent mesh panels, and the second connection member runs through the slide groove.

In the above technical solution, the pet crate further includes:
a fixing member, where the fixing member is connected to a mesh panel of the plurality of mesh panels, and a threaded hole is provided on a mesh panel adjacent to the mesh panel of the plurality of mesh panels and is corresponding to the fixing member.

Additional aspects and advantages of the present disclosure will be apparent from the description below, or understood through practice of the present disclosure.

### BRIEF DESCRIPTION OF THE DRAWINGS

The above and/or other additional aspects and advantages of the present disclosure will become apparent and comprehensible from the description of embodiments made in connection with the accompanying drawings, in which:

FIG. 1 is an overall schematic structural view of the present disclosure.

FIG. 2 is a schematic structural front view of the present disclosure.

FIG. 3 is a schematic structural view of a mesh panel of the present disclosure.

FIG. 4 is a schematic structural enlarged view of part A of the present disclosure.

FIG. 5 is a schematic structural view of a mesh panel of the present disclosure.

FIG. 6 is a schematic structural view of a first connection member of the present disclosure.

### DETAILED DESCRIPTION OF THE EMBODIMENTS

To make the objectives, features, and advantages of the present disclosure more comprehensible, the present disclosure will be described in detail below with reference to the accompanying drawings and specific embodiments. It should be noted that the embodiments of the present disclosure and the features in the embodiments may be combined with each other without conflict.

Many specific details are set forth in the following description to provide a full understanding of the present disclosure. However, the present disclosure can also be implemented in other ways different from those described herein, so the scope of protection of the present disclosure is not limited by the specific embodiments disclosed below.

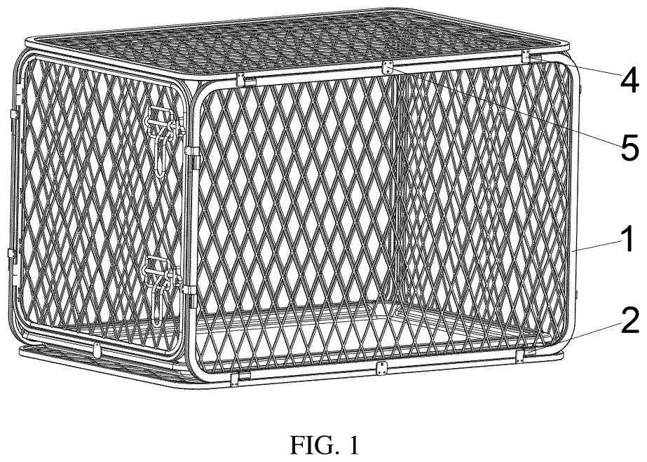

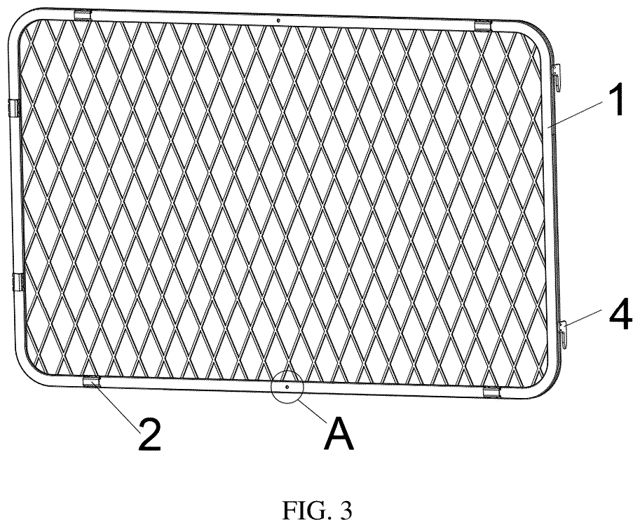

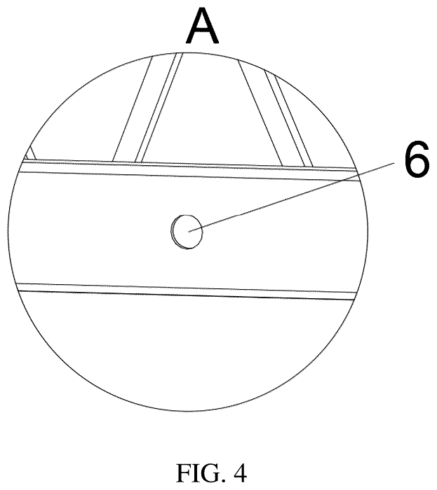

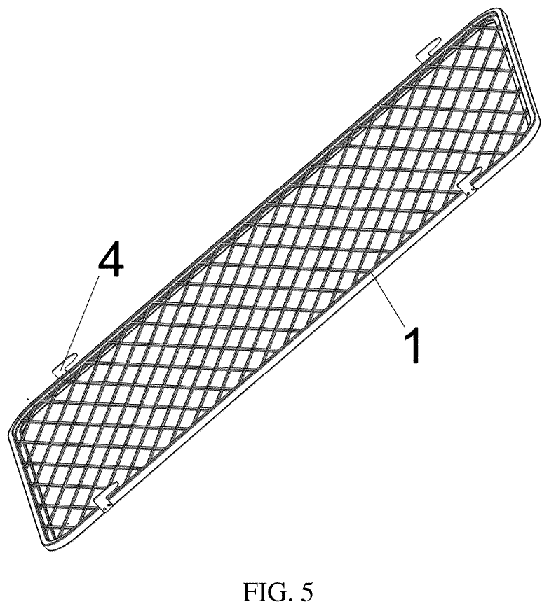

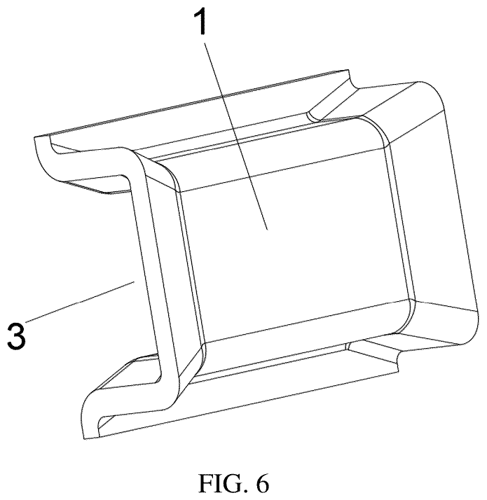

A pet crate according to some embodiments of the present disclosure will be described below with reference to FIG. 1 to FIG. 6.

As shown in FIG. 1 to FIG. 6, an embodiment of the present disclosure provides a pet crate, including:
a plurality of mesh panels 1, where the plurality of mesh panels 1 are configured to define a closed accommodating chamber;
a door, where the door is rotatably connected to one of the plurality of mesh panels 1; and
connection assemblies, where each of the connection assemblies is arranged between two respective adjacent mesh panels 1 of the plurality of mesh panels 1.

During mounting, an edge of a mesh panel 1 of the plurality of mesh panels 1 is aligned with an edge of another mesh panel 1 of the plurality of mesh panels 1, and then the mesh panel 1 is slid along a direction, so that the two mesh panels 1 are assembled by the connection assembly. This process does not require the use of a large number of screws to assemble the two mesh panels 1, and the two mesh panels 1 can be connected by a simple sliding action, so that the mounting process is simplified, and the mounting efficiency is greatly improved.

As shown in FIG. 1 to FIG. 6, in an embodiment of the present disclosure, each of the connection assemblies includes:
a first connection member 2, where the first connection member 2 is arranged at a connection between the two respective adjacent mesh panels 1 and is fixedly connected to one of the two respective adjacent mesh panels 1, and a slide groove 3 is provided on the first connection member 2; and
a second connection member 4, where the second connection member 4 is arranged at the connection between the two respective adjacent mesh panels 1 and is fixedly connected to the other of the two respective adjacent mesh panels 1, and the second connection member 4 runs through the slide groove 3.

The pet crate further includes:
a fixing member 5, where the fixing member 5 is connected to a mesh panel 1 of the plurality of mesh panels 1, and a threaded hole 6 is provided on a mesh panel 1 adjacent to the mesh panel 1 of the plurality of mesh panels 1 and is corresponding to the fixing member 5.

The present disclosure is described using an example where the pet crate includes six mesh panels 1. The six mesh panels 1 include a lower mesh panel 1, an upper mesh panel 1, a first side mesh panel 1, a second side mesh panel 1, a third side mesh panel 1, and a fourth side mesh panel 1. The first side mesh panel 1, the second side mesh panel 1, the third side mesh panel 1, and the fourth side mesh panel 1 are connected end to end in sequence. Then, the first side mesh panel 1, the second side mesh panel 1, the third side mesh panel 1, and the fourth side mesh panel 1 are mounted between the upper mesh panel 1 and the lower mesh panel 1. The first side mesh panel 1, the second side mesh panel 1, the third side mesh panel 1, and the fourth side mesh panel 1 are respectively arranged at a front end, a left end, a rear end, and a right end of the lower mesh panel 1. Thus, a pet crate of a cuboid structure is formed. A specific mounting process is as follows.

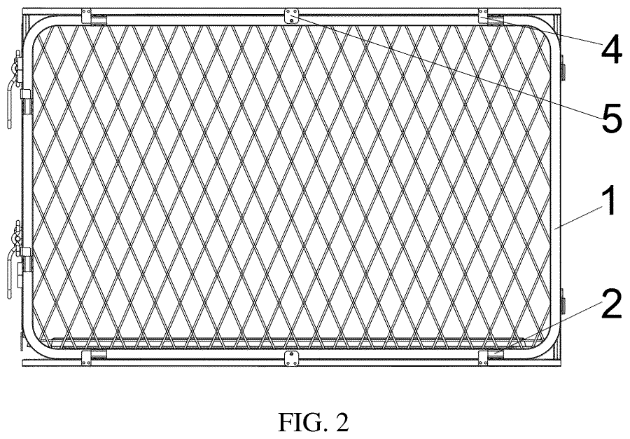

For example, referring to FIG. 2, two second connection members 4 are fixedly connected at each of the front end and the rear end of the lower mesh panel 1, and two first connection members 2 are fixedly connected at a lower end of each of the first side mesh panel 1 and the third side mesh panel 1. In this case, to mount the pet crate, the lower mesh panel 1 is fixed first, and then the two first connection members 2 at the lower end of the first side mesh panel 1 are respectively arranged on a right side of the two second connection members 4 at the front end of the lower mesh panel 1. Then, the first side mesh panel 1 is pushed from right to left, so that the two second connection members 4 at the front end of the lower mesh panel 1 are respectively inserted into the two first connection members 2 at the lower end of the first side mesh panel 1, thereby connecting the front end of the lower mesh panel 1 to the lower end of the first side mesh panel 1. Based on the same principle, the rear end of the lower mesh panel 1 is connected to the lower end of the third side mesh panel 1. Then, because first connection members 2 are fixedly connected at each of a left end of the first side mesh panel 1 and a left end of the third side mesh panel 1, and second connection members 4 are fixedly connected at each of a front end and a rear end of the second side mesh panel 1, the second side mesh panel 1 is placed at the left end of the first side mesh panel 1 and the left end of the third side mesh panel 1, so that the second connection members 4 at the front end of the second side mesh panel 1 are located above the first connection members 2 at the left end of the first side mesh panel 1, and the second connection members 4 at the rear end of the second side mesh panel 1 are located above the first connection members 2 at the left end of the third side mesh panel 1. Then, the second side mesh panel 1 is slid downward, so that the second connection members 4 at the front end and the rear end of the second side mesh panel 1 are respectively inserted into the first connection members 2 at the left end of the first side mesh panel 1 and the first connection members 2 at the left end of the third side mesh panel 1, thereby respectively connecting the front end and the rear end of the second side mesh panel 1 to the left end of the first side mesh panel 1 and the left end of the third side mesh panel 1. Based on the same principle, a front end and a rear end of the fourth side mesh panel 1 are respectively connected to a right end of the first side mesh panel 1 and a right end of the third side mesh panel 1. Then, because first connection members 2 are fixedly connected at each of an upper end of the first side mesh panel 1 and an upper end of the third side mesh panel 1 and second connection members 4 are fixedly connected at each of a front end and a rear end of the upper mesh panel 1, the upper mesh panel 1 is pushed from left to right, so that the second connection members 4 at the front end and the rear end of the upper mesh panel 1 are respectively inserted into the first connection members 2 at the upper end of the first side mesh panel 1 and the first connection members 2 at the upper end of the third side mesh panel 1, thereby connecting the upper mesh panel 1 to the first side mesh panel 1 and the third side mesh panel 1. Thus, the preliminary mounting of the entire pet crate is completed. The above mounting process is simple, and two adjacent mesh panels 1 can be conveniently connected by respectively inserting the two second connection members 4 into the slide grooves 3 on the two first connection members 2, so that the mounting efficiency is greatly improved. In addition, the arrangement of two first connection members 2 and two second connection members 4 between two adjacent mesh panels 1 can improve the stability of connection between the two adjacent mesh panels 1.

In addition, using FIG. 2 as an example, a fixing member 5 is fixedly connected at the front end of the lower mesh panel 1. The fixing member 5 is arranged between the two second connection members 4 at the front end of the lower mesh panel 1. A threaded hole 6 is provided at the lower end of the first side mesh panel 1. The threaded hole 6 is arranged between the two first connection members 2 at the lower end of the first side mesh panel 1. A screw is passed through the fixing member 5 at the front end of the lower mesh panel 1 and the threaded hole 6 at the lower end of the first side mesh panel 1 to improve the stability of connection between the first side mesh panel 1 and the lower mesh panel 1. A threaded hole 6 is provided at each of the upper end of the first side mesh panel 1 and the upper end and the lower end of the third side mesh panel 1, and a fixing member 5 is fixedly connected at each of the rear end of the lower mesh panel 1 and the front end and the rear end of the upper mesh panel 1. Based on the same principle, the stability of connection between the upper end of the first side mesh panel 1 and the front end of the upper mesh panel 1, between the upper end of the third side mesh panel 1 and the rear end of the upper mesh panel 1, and between the lower end of the third side mesh panel 1 and the rear end of the lower mesh panel 1 can be improved through the engagement of the fixing members 5 and the threaded holes 6. In addition, because one fixing member 5 is fixedly mounted only at each of the front end of the lower mesh panel 1, the rear end of the lower mesh panel 1, the front end of the upper mesh panel 1, and the rear end of the upper mesh panel 1, and one threaded hole 6 is provided only at each of the lower end of the first side mesh panel 1, the upper end of the first side mesh panel 1, the lower end of the third side mesh panel 1, and the upper end of the third side mesh panel 1, only four screws are required. As such, compared with the prior art where the pet crate needs to be mounted using a large number of screws, the pet crate of the present disclosure requires fewer screws and can be mounted more conveniently.

In the above mounting process, two adjacent mesh panels 1 can be assembled together by respectively inserting the two second connection members 4 into the slide grooves 3 on the two first connection members 2 without using a large number of screws. As such, the mounting process is simplified, and the mounting efficiency is greatly improved. The arrangement of the first connection members 2, the second connection members 4, the threaded hole 6, and the fixing member 5 between two adjacent mesh panels 1 greatly improves the stability of connection between the two adjacent mesh panels 1.

The present disclosure has the following advantages.

1. Through the arrangement of the connection assembly between two adjacent mesh panels 1, the two adjacent mesh panels 1 may be assembled together by sliding one of the two adjacent mesh panels 1 relative to the other of the two adjacent mesh panels 1. As such, the number of screws used is reduced, and the mounting efficiency is greatly improved.

2. Through the arrangement of the fixing member 5 and the threaded hole 6 between two adjacent mesh panels 1, the stability of connection between the two adjacent mesh panels 1 is improved through the engagement of the fixing member 5 and the threaded hole 6. As such, the shaking of the entire pet crate is reduced.

In the present disclosure, the terms such as “mount”, “connect”, “couple”, “fix”, and variants thereof should be interpreted in a broad sense. For example, “connection” may be a fixed connection, a detachable connection, or an integral connection; and “connection” may also be a direct connection or an indirect connection through an intermediate medium. For those of ordinary skill in the art, the specific meanings of the above terms in the present disclosure can be understood according to specific circumstances.

In the description of the present disclosure, it should be understood that the orientation or positional relationships indicated by the terms such as “inner” and “outer” are based on orientation or position relationships shown in the accompanying drawings, and are used only for ease and brevity of illustration and description, rather than indicating or implying that the mentioned apparatus or unit must have a particular orientation or must be constructed and operated in a particular orientation. Therefore, such terms should not be construed as limiting of the present disclosure.

In the description of this specification, the description with reference to the terms such as “an embodiment”, “some embodiments”, and “specific embodiment” means that specific features, structures, materials, or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments or examples.

The above description is merely preferred embodiments of the present disclosure, and is not intended to limit the present disclosure. To those skilled in the art, various modifications and variations may be made to the present disclosure. Any modification, equivalent replacement, or improvement made without departing from the spirit and principle of the present disclosure shall fall within the scope of protection of the present disclosure.

1. A pet crate, comprising:
a plurality of mesh panels, wherein the plurality of mesh panels are configured to define a closed accommodating chamber;
a door, wherein the door is connected to one of the plurality of mesh panels; and
connection assemblies, wherein each of the connection assemblies is arranged between two respective adjacent mesh panels of the plurality of mesh panels.

2. The pet crate according to claim 1, wherein
each of the connection assemblies comprises:
a first connection member, wherein the first connection member is arranged at a connection between the two respective adjacent mesh panels and is connected to one of the two respective adjacent mesh panels, and a slide groove is provided on the first connection member; and
a second connection member, wherein the second connection member is arranged at the connection between the two respective adjacent mesh panels and is connected to the other of the two respective adjacent mesh panels, and the second connection member runs through the slide groove.

3. The pet crate according to claim 2, further comprising:
a fixing member, wherein the fixing member is connected to a mesh panel of the plurality of mesh panels, and a threaded hole is provided on a mesh panel adjacent to the mesh panel of the plurality of mesh panels and is corresponding to the fixing member.
